(19) United States
(12) Patent Application Publication
(10) Pub. No.: US 2026/0295405 A1
(43) Pub. Date: Oct. 1, 2026

(54) PERSISTENT STATE GAMING DEVICE

(71) Applicant: Stern Pinball, Inc., Elk Grove Village, IL (US)

(72) Inventors: Brian Eddy, Elk Grove Village, IL (US); Dwight Sullivan, Elk Grove Village, IL (US)

(21) Appl. No.: 19/636,189

(22) Filed: Apr. 1, 2026

Related U.S. Application Data
(60) Provisional application No. 63/781,760, filed on Apr. 1, 2025.

(51) Int. Cl. A63F 13/49; A63F 7/02; A63F 13/335

(52) U.S. Cl. CPC A63F 13/49; A63F 7/027; A63F 13/335

(57) ABSTRACT

A method of operating a pinball machine includes initiating a first gaming session associated with a user identifier, receiving user inputs from one or more game input devices, updating a game state based on the received user inputs, transmitting the game state to a remote server for association with the user identifier, initiating a second gaming session associated with the user identifier, obtaining the game state based on the user identifier, and configuring the second gaming session based on the game state.

### CROSS-REFERENCE TO RELATED APPLICATIONS

This application claims the benefit of U.S. Provisional Application No. 63/781,760, filed Apr. 1, 2025, entitled “PERSISTENT STATE GAMING DEVICE,” the entirety of which is incorporated herein by reference.

### TECHNICAL FIELD

The present disclosure relates generally to gaming and more particularly to gaming devices, such as pinball machines, networked for state persistence.

### BACKGROUND

Gaming devices of the commercial (e.g., revenue generating) and non-commercial (e.g., home entertainment) type include pinball machines, redemption games, etc., which include physical and virtual elements as part of their games. By way of example, U.S. Pat. Nos. 5,338,031 and 6,158,737, and U.S. Application No. 2007/0026918 are each incorporated by reference herein and illustrate and describe gaming devices of the type having a cabinet that houses a playfield.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a diagram of an example gaming device in the form of a pinball machine, in accordance with one or more embodiments.

FIG. 2 is a block diagram of example components of the gaming device of FIG. 1, in accordance with one or more embodiments.

FIG. 3 is a flow diagram of an example process for persisting game states, in accordance with one or more embodiments.

FIG. 4 is a flow diagram of an example process performed by a remote server, in accordance with one or more embodiments.

FIG. 5 is a block diagram of an example computing system, in accordance with one or more embodiments.

### DETAILED DESCRIPTION

Traditional gaming devices are often designed around isolated, short-lived play sessions, with all player progress, choices, and in-game developments reset at the end of each game. This model limits narrative depth, long-term engagement, and player personalization, as it offers no mechanism for preserving the evolving relationship between the player and the game across sessions or locations.

To address this limitation, the present disclosure includes a system that allows players to save and restore “states,” which include discrete packages of data that represent the current status of the player and/or virtual/physical status of the game itself. These states are referred to herein as “game states” or “game state objects,” and may also be referred to as “session records” or “saved session records.” Game states may include user-specific attributes (e.g., character selection, inventory, progression through quests, or achievement milestones) and/or game-specific attributes (e.g., procedurally generated content such as map layouts, pathways or item placements; unlocked features; or score data and machine-specific progressions). The user identifier used to associate a game state with a particular user may also be referred to herein as a “player credential” or “player identifier.”

A technical challenge lies in enabling this level of continuity in a networked, globally distributed environment, where a player may wish to resume gameplay from any connected gaming device in the world. The system stores, retrieves, and/or updates saved states in real time, while giving players the flexibility to manage multiple states, reset their progress when desired, and experience persistent gameplay narratives across machines and sessions. A player may maintain multiple game state objects, each corresponding to a respective “save slot.” For example, a player who has access to eight playable characters may maintain a separate save slot for each character, with each save slot preserving the character data, inventory data, and progression data accumulated for that character across prior gaming sessions. A player may also request a reset of a particular save slot, which replaces the corresponding game state object with an initial session record comprising default values (e.g., starting location, empty inventory, no quest progress). In some embodiments, a game state may be associated with a particular gaming device identifier rather than, or in addition to, a user identifier, such that game data accumulated on a specific gaming device is preserved independently of any particular player. Introducing a robust state-saving architecture enables a connected, player-driven experience that brings the narrative continuity, customization, and engagement of digital gaming into gaming devices.

In some embodiments, the system may provide a competition mode as a selectively enabled operating mode for tournament play or other competitive play in which different players are to be presented with substantially equivalent starting conditions. When the competition mode is active, the system may cause a gaming device to initialize gameplay from a baseline game state corresponding to a beginning state of a selected game and may disregard a player-specific saved session record. The baseline game state may correspond to an initial session record comprising default values, such as a starting location, a default character state, a default inventory, and reset score values. The competition mode may remove or substantially reduce randomness from the game by disabling randomized state generation and/or substituting predetermined values for randomized values. For example, procedurally generated content, award selections, map layouts, item placements, mode ordering, or other variable gameplay parameters may be fixed according to a predefined competition configuration or a common seed value such that different players encounter the same gameplay conditions during respective competition sessions.

Referring now to the figures, wherein like numerals refer to the same or similar features in the various figures, the following detailed description is made with respect to a gaming device in the example form of a pinball machine. It is to be appreciated, however, that this example form for the gaming device is not intended to be limiting. Rather, those of ordinary skill in the art will appreciate that the gaming device disclosed hereinafter can be utilized in any type of gaming device of the commercial and non-commercial type in which it is desired to create a networked amusement machine as disclosed.

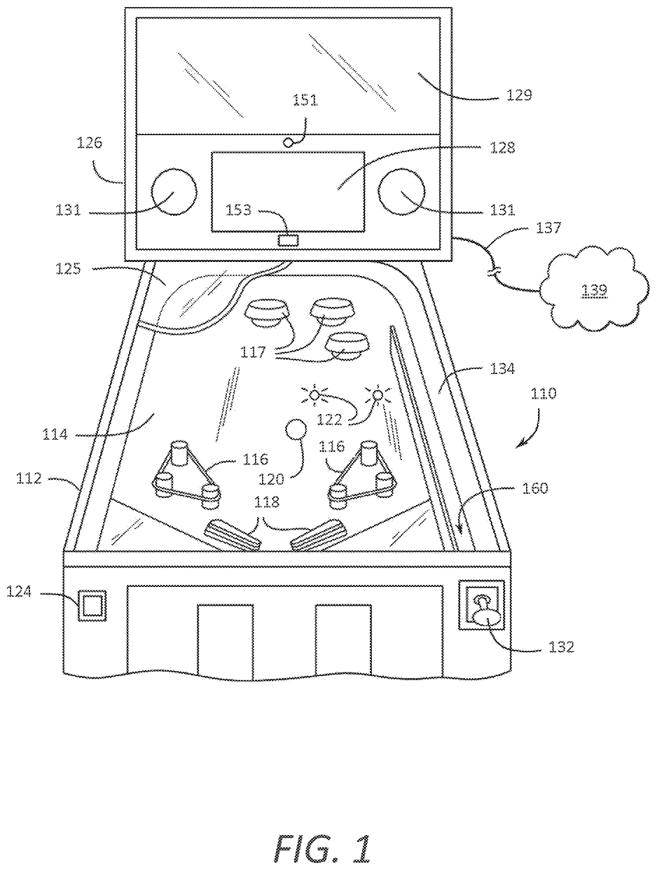

FIG. 1 is a diagram of an example pinball machine 110, in accordance with one or more embodiments. The example pinball machine 110 includes a cabinet 112 which houses various components used to define play of a game. Gameplay may be commenced in response to insertion of money, tokens, or other objects (referred to collectively as “coins”) into a coin accepting device, upon exercising of credits earned, by accepting payment from an account (e.g., via use of a swipe card reading device, a bar code reading device, a near field communications device, etc.) and/or by otherwise making game play active, including free play. Upon activation of the game in this manner, gameplay, in the case of the example pinball machine 110, is defined upon a playfield 114 that supports a number of playfield accessories or devices.

More particularly, in the case of the example pinball machine 110, gameplay is generally defined through the use of a pair of flippers 118 to propel a ball 120 relative to an upper side (e.g., a top surface) of the playfield 114 and input devices/accessories associated with the playfield 114. The playfield 114 may be inclined from the horizontal, such as for instance between approximately 6.5 to 7.0 degrees, such that the ball tends to eventually roll back down the playfield 114 in the direction of the flippers 118. While not intended to be limiting, the playfield accessories or input devices may include elements such as bumpers 116, ramps, rollover switches 122, targets, or any other suitable accessories. These playfield accessories, including bumpers 116, drop targets 117, ramps, rollover switches 122, flippers 118, and associated lighting elements, may be referred to collectively herein as “electromechanical components” of the playfield 114.

The playfield 114 may be covered by a transparent or glass sheet cover 125 to permit viewing of the playfield 114. In addition to the foregoing, the playfield 114 may include a plunger element 132 which shoots or launches the ball 120 up an alley 134 onto the playfield 114. The playfield 114 may also include lighting elements (which may also be included as a part of any of the input devices/accessories) and/or other features as desired. Other player-activated input elements, such as buttons (not shown) on the sides (or other location) of the cabinet 112, may be provided for controlling operation of the flippers 118 or otherwise interacting with gameplay.

The pinball machine 110 may also include a backbox 126 which is mounted to overlay a top rear portion of the cabinet 112 and which in this example contains artwork 129, and a display 128 (e.g., a dot matrix display, CRT, LED or plasma display, or the like) for game graphics. The backbox 126 may also support speakers 131 associated with the game sound. Within the backbox 126 may be located various ones of the electronic devices/circuits for controlling the operation of the playfield 114, the display 128, general illumination, and the sound system, including speakers 131 and any additional sound system components. Still further, the backbox 126 may include a camera 151 and/or a microphone 153, which may be mounted to any suitable portion of the pinball machine 110, and may be separately or integrally mounted as desired, to allow for video and/or sound functionality. Such electronic devices/circuits could also, in whole or in part, be carried within the game cabinet 112, or may be external to the game cabinet and linked to the machine 110 via any suitable wired or wireless configuration. In some examples, the camera 151 and/or of the microphone 153 may be integral with or a supplement to the access device 124, such as in the instance of facial and/or voice recognition.

As previously described, during operation, a pinball gameplay often is a discrete event, performed for example, on a local machine, such as the example pinball machine 110, and completed once the game is over and all the balls are played. In the present example, however, the example pinball machine comprises a network connection 137 that couples the machine 110 to a network 139, such as the Internet, Intranet, LAN, WAN, cloud server, or other suitable network. The network connection 137 may be any suitable wired connection or wireless connection as desired and may facilitate the communication of the machine 110 with a remote server 141 as disclosed herein.

In addition to the network connection 137, the example pinball machine may include an access device 124 to facilitate identification of the user of the machine 110 during gameplay. The access device 124 may be constructed separate from, or in combination with, the coin acceptance device noted above. The access device 124 may include an optical reader, such as a bar code reader or camera, configured to read a code (e.g., a QR code, bar code, or other machine-readable code) presented by a user in physical form (e.g., a piece of paper, card, or coupon) and/or in electronic form (e.g., a phone app or other mobile device display). In some embodiments, the access device 124 may include a near field communications (NFC) device, a swipe card reading device, a magnetic stripe reader, a biometric sensor, or any other suitable device capable of capturing identifying information from a user. In some embodiments, the camera 151 and/or the microphone 153 may serve as the access device 124 or a supplement thereto, such as in the instance of facial recognition or voice recognition. A user identifier, credential, code, or other identifying information captured by the access device 124 may be referred to herein as a “player credential.”

It should be understood that not all of the depicted components of FIG. 1 may be used in all embodiments, and one or more embodiments may include additional, fewer, or different components than those shown in the figure. Variations in the arrangement and type of components may be made without departing from the spirit or scope of the claims as set forth herein.

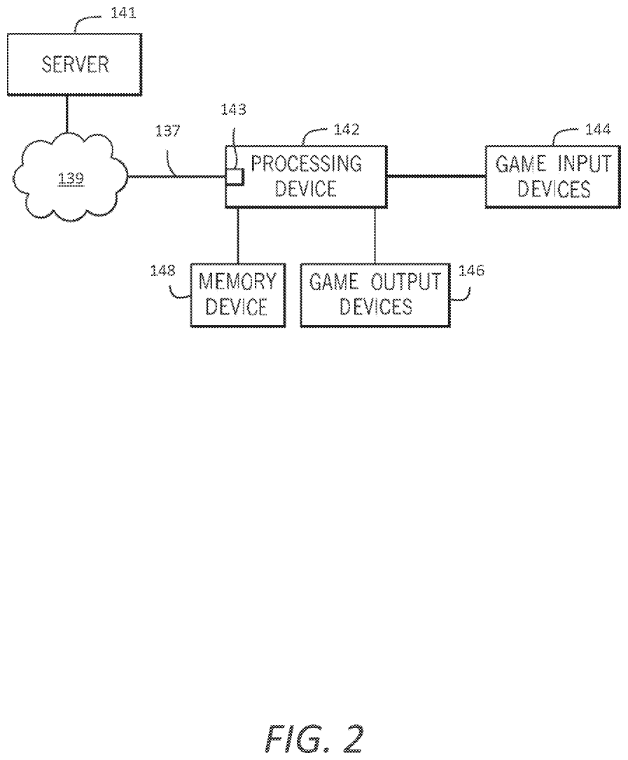

FIG. 2 is a block diagram of example components that form the gaming device, in accordance with one or more embodiments. The pinball machine 110 is provided with a processing device 142 which processing device 142 is, in turn, coupled to game input devices 144, such as switches associated with the cabinet 112, the playfield 114, the access device 124, etc., and game output devices 146, such as lights, bumpers 116, flippers 118, display 128, speakers 131, etc. via one or more busses. The processing device 142 may comprise one or more processors configured to execute instructions stored in the memory device 148.

A memory device 148, such as a RAM, ROM, or the like, stores instructions and data usable by the processing device 142 to control play of the game, the game output devices 146, and the game input devices 144 as necessary based upon signals provided by the game input devices 144. It is to be understood that this illustrated embodiment is not intended to be limiting and that other manners for arranging the devices illustrated in FIG. 2 to provide for control of play of the gaming can be utilized as needed.

In the present example, the processing device 142 is also electrically coupled to the network 139 and the server 141 through the network connection 137. Accordingly, the processing device 142 includes an input/output device or port 143 that communicates with the network connection 137. The input/output device may be any suitable device, including for instance a receiver, a transmitter, a transceiver, etc. utilizing any suitable protocol.

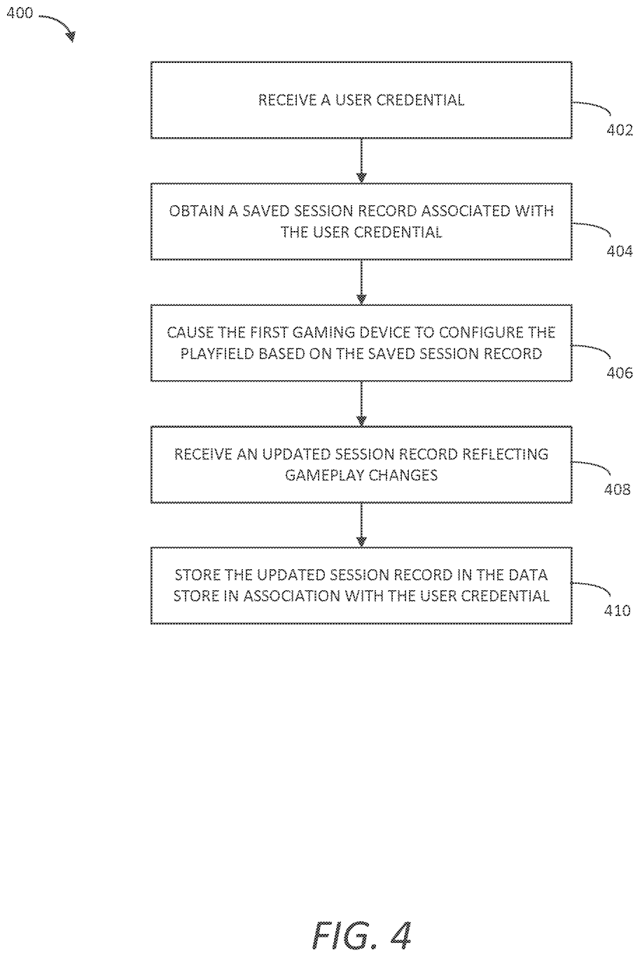

The computing device that embodies the pinball machine 110 and/or the server 141 is described in further detail below with respect to FIG. 4.

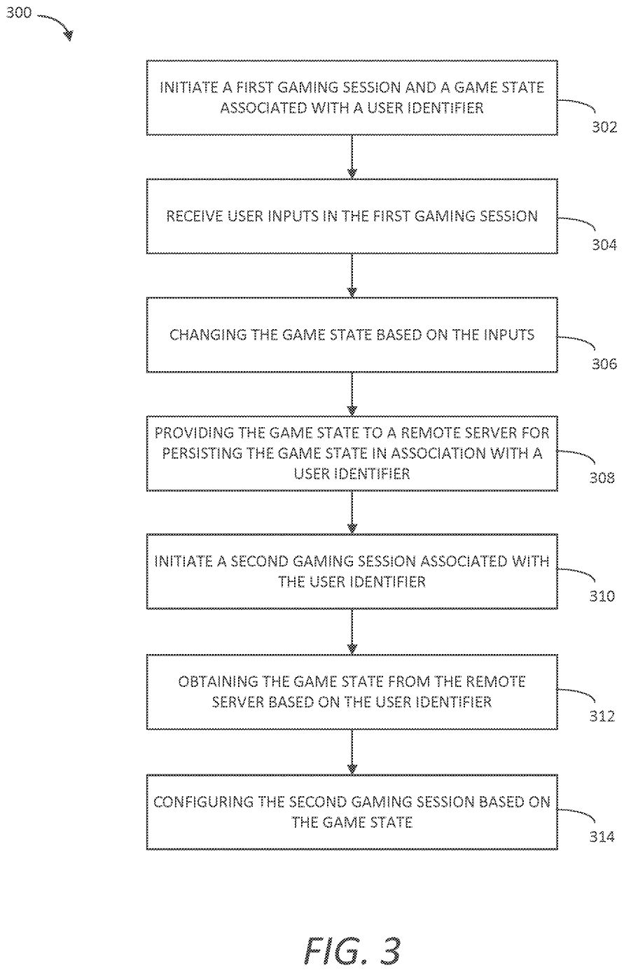

FIG. 3 is a flow diagram of an example process 300 for persisting game states by the pinball machine 110, in accordance with one or more embodiments. For explanatory purposes, FIG. 3 is described herein with reference to the pinball machine 110 of FIG. 1, and thus the process 300 may be a computer-implemented method. However, this is merely illustrative, and process 300 may be performed by any other system suitable for implementing the process 300. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

At operation 302, the pinball machine 110 initiates a first gaming session. The pinball machine 110 may be connected to the internet and be equipped with an access device 124, such as a QR code scanner or touchscreen login system. A user may log into the pinball machine 110 by inputting a user identifier via the access device 124. For example, the user may scan a personalized QR code using their mobile device, which securely identifies them to the access device 124.

This login event may trigger a handshake between the pinball machine 110 and a server 141. The server 141 may verify the user's identity and determine whether this is a new or returning player. In the case of a new player, a new initial game state object may be created in memory and associated with the user's identifier. The initial game state object may be created by the server 141 and transmitted to the gaming device, or may be created locally by the processing device 142 of the gaming device based on default configuration data. The game state may include default values such as starting at location 1 on a map, no character selected, and an empty inventory. For example, the initial game state could be structured in the following JSON:

```
{
  “user_id”: “UID_123456”,
  “location”: “Start Village”,
  “character”: null,
  “inventory”: [ ],
  “quest_progress”: [ ],
  “scores”: [ ]
}
```

In the case of a returning player, the user may select from the available saved game states via a selection interface presented on the display 128 of the pinball machine 110. Each available saved game state may correspond to a respective save slot. For example, the user may have a game state for each of a set of characters. In some embodiments, the user may select a previous version of a saved game state from a version selection interface that presents a plurality of prior versions maintained by the server 141. In some embodiments, the user may select a game state associated with a particular pinball machine.

The first gaming session may correspond to the period of time during which the logged in user interacts with the pinball machine 110. The first gaming session may correspond to a session identifier and may be terminated when the user logs out or after a period of inactivity.

At operation 304, the pinball machine 110 receives user inputs in the first gaming session. As the user begins to play, the user interacts with game input devices 144 of the pinball machine 110. For instance, the player may navigate through an in-game menu to choose a character, launch the ball into play, and trigger events in the game such as activating certain targets or unlocking secret passages. Each input may be logged and interpreted by the processing device 142, forming a stream of gameplay interactions that can impact game and/or player attributes such as scores, achievements, badges, quests, and/or the like.

At operation 306, the pinball machine 110 changes the game state based on the received user inputs. As the user inputs are processed, they cause real-time changes to the game state (e.g., game and player attributes). For example, hitting certain targets may unlock a dungeon door, adding a “Dungeon Key” to the player's inventory; choosing a character sets that character as the active avatar for the session; scoring events updates score counters and progress bars.

The received user inputs may include inputs corresponding to player choices that define a narrative decision or branching event. Such choices may be inferred from physical gameplay actions, such as completing a designated shot or activating a target associated with a decision point, or may be explicitly received via a user interface prompt presented on the display. The processing device 142 may update the game state to include the selected choice and may adjust subsequent gameplay behavior, including available modes, playfield configurations, storyline progression, and potential outcomes, based on the chosen option.

The processing device 142 may incrementally modify the game state in the memory device 148 throughout the first gaming session. For example, by the end of the first ball, or at any other logical checkpoint, the game state might look like the following JSON to reflect the sum of the user's choices and actions resulting from the received inputs:

```
{
  “user_id”: “UID_123456”,
  “location”: “Dungeon Level 1”,
  “character”: “Mage”,
  “inventory”: [“Torch”, “Dungeon Key”],
  “quest_progress”: [“Activated Gate”],
  “scores”: [752500]
}
```

At operation 308, the pinball machine 110 provides the game state to the server 141 for persisting the game state. Throughout gameplay or at defined checkpoints (e.g., end of ball, mode completion, or player logout), the pinball machine 110 may periodically transmit the updated game state to the server 141. The transmission may use an API associated with the server 141 and include the user identifier as a key to associate the data with the user.

The server 141 may validate the incoming data, generate a timestamp, and/or store the game state as a session record in its data store. For example, the game state may be stored in a structured, queryable format, such as a document-based or key-value store (e.g., the data store of the server 141) that can rapidly retrieve data based on a user identifier. The server 141 may further generate a version identifier for each stored session record, enabling the data store to maintain a plurality of prior versions of the session record associated with a given user identifier. When a player credential is received from any gaming device connected to the server 141 via the network 139, the server 141 may retrieve the corresponding session record from the data store and transmit the session record to the requesting gaming device, thereby causing the gaming device to configure gameplay based on the session record. In this manner, the server 141 operates as a centralized persistence layer that receives player credentials, retrieves and transmits session records, receives updated session records, validates incoming data, and stores the updated session records, each in association with the corresponding player credential.

At operation 310, the pinball machine 110 may initiate a second gaming session associated with the user identifier. At a later time and possibly on a completely different pinball machine, the user may log in as they did at operation 302, which causes the pinball machine 110 to initiate the second gaming session.

At operation 312, the pinball machine 110 may obtain the game state from the server 141 based on the user identifier. The pinball machine 110 may call the server 141 to look up the most recent saved game state associated with the user's identifier. This lookup may be executed via an authenticated API request, which returns the game state. Where the user identifier is associated with a plurality of game state objects (e.g., corresponding to respective save slots), the server 141 may transmit the plurality of game state objects to the pinball machine 110, and the pinball machine 110 may present the plurality of game state objects in a selection interface on the display 128. The pinball machine 110 may download the saved game state into its memory device 148. The pinball machine 110 now knows where the user left off and may prepare to configure the playfield 114 accordingly.

At operation 314, the pinball machine 110 may configure the second gaming session based on the game state. With the game state obtained, the pinball machine 110 may configure virtual and/or physical elements of gameplay to reflect the game state.

Configuring virtual elements may include, for example, adjusting UI elements (e.g., displaying the user's selected character as a character avatar), loading the correct in-game map section (e.g., “Dungeon Level 1”), re-enabling completed quests, and updating scoring metrics (e.g., score counters, progress bars, and other score metrics displayed on the display 128).

Configuring physical elements may include enabling or disabling access to certain ramps or playfield 114 areas to reflect unlocked zones, activating or deactivating bumpers 116 or drop targets 117 according to the user's quest progress, lighting up specific inserts or rollover switches 122.

In some embodiments, the game state may include procedurally generated content, such as a dungeon layout, world map, pathway configuration, or item placement, among others, that is generated according to a procedural generation algorithm. The procedurally generated content may be stored by the server 141 and synchronized across the plurality of gaming devices connected to the server 141 via the network 139. The procedurally generated content may change over a defined timeframe, and updated procedurally generated content may be distributed by the server 141 to each connected gaming device. In this manner, players engaging with a particular game title across different gaming devices may experience the same procedurally generated environment during a given time period.

As gameplay continues, new user inputs may cause the pinball machine 110 to modify the game state, and this updated state may again be periodically synchronized with the server 141, maintaining a persistent loop of progression and personalization.

FIG. 4 is a flow diagram of an example process 400 for persisting game states by the server 141, in accordance with one or more embodiments. For explanatory purposes, FIG. 4 is described herein with reference to the server 141 communicatively coupled to a plurality of gaming devices, including the pinball machine 110 of FIG. 1, via the network 139. The process 400 may be a computer-implemented method performed by one or more processors of the server 141. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

At operation 402, the server 141 receives a player credential from a first gaming device of the plurality of gaming devices connected to the server 141 via the network 139. The player credential may be received by an access device 124 of the first gaming device, such as an optical reader configured to read a QR code presented by a user, a near field communications device, a swipe card reading device, or any other suitable access device as described above with respect to FIG. 1. The server 141 may authenticate the player credential by comparing it against stored credentials in the data store of the server 141. Upon successful authentication, the server 141 may determine whether the player credential is associated with one or more previously saved session records in the data store.

At operation 404, the server 141 obtains a saved session record associated with the player credential from the data store. The saved session record may include user-specific attributes and game-specific attributes accumulated during one or more prior gaming sessions on one or more of the plurality of gaming devices. User-specific attributes may include, for example, character selection data, inventory data, progression data, achievements, badges, and contest results, among other data. Game-specific attributes may include, for example, map layout data, unlocked feature data, score data, and procedurally generated content such as dungeon layouts, world maps, pathway configurations, or item placements, among other procedurally generated content.

In some embodiments, the data store may maintain a plurality of saved session records associated with the player credential, each saved session record corresponding to a respective save slot. For example, a player who has access to multiple playable characters may have a separate save slot for each character. In such cases, the server 141 may transmit the plurality of saved session records to the first gaming device, causing the first gaming device to present a selection interface on its display 128. The selection interface may identify each available save slot, enabling the user to select which saved session record to restore. The server 141 may then receive an indication of the selected saved session record from the first gaming device and proceed with the selected saved session record.

In some embodiments, the data store may maintain a plurality of prior versions of a saved session record associated with a given save slot. The server 141 may generate a version identifier for each stored version of the session record. When the player credential is associated with multiple prior versions, the server 141 may transmit the plurality of prior versions to the first gaming device, causing the first gaming device to present a version selection interface that allows the user to select a particular prior version for restoration.

At operation 406, the server 141 causes the first gaming device to configure the playfield based on the saved session record. The server 141 may transmit the saved session record (or the selected saved session record, where multiple save slots or prior versions are available) to the first gaming device via the network 139. Upon receiving the saved session record, the first gaming device may configure virtual and/or physical elements of gameplay to reflect the saved session record. Configuring virtual elements may include adjusting UI elements displayed on the display 128 of the first gaming device, such as displaying a character avatar corresponding to the user's selected character, loading the correct in-game map section, and updating score metrics. Configuring physical elements may include selectively activating or deactivating one or more electromechanical components of the playfield 114 according to the saved session record, such as activating or deactivating bumpers 116 or drop targets 117, enabling or disabling access to ramps, or illuminating rollover switches 122 to reflect the user's quest progress and unlocked zones.

The saved session record may include player choice data representing one or more prior choices that affect the storyline or progression of the game. When transmitting the saved session record to a gaming device, the server 141 may cause the gaming device to resume gameplay in a manner consistent with the previously selected narrative path. Updated player choice data received from a gaming device may be validated and stored as part of an updated session record, thereby preserving branching gameplay progression across sessions and devices.

At operation 408, the server 141 receives an updated session record from the first gaming device reflecting gameplay changes occurring during a current gaming session. As the user interacts with the first gaming device, the processing device 142 of the first gaming device may modify the game state in real time based on user inputs received via game input devices 144. The first gaming device may periodically transmit the updated session record to the server 141 at defined checkpoints, such as an end-of-ball event, a mode completion event, or a user logout event, or at other intervals as determined by the first gaming device. The updated session record may reflect changes to user-specific attributes (e.g., new inventory items, updated quest progress) and game-specific attributes (e.g., newly unlocked features, updated scores) relative to the saved session record obtained at operation 404.

At operation 410, the server 141 stores the updated session record in the data store in association with the player credential. The server 141 may validate the updated session record received from the first gaming device prior to storage, for example by checking data integrity, verifying that the session record conforms to an expected schema, or confirming that the player credential matches the session from which the update originated. Upon successful validation, the server 141 may generate a version identifier and/or a timestamp to associate with the updated session record, and store the updated session record in the data store. The data store may retain the updated session record alongside one or more prior versions of the session record, enabling the user to select a prior version for restoration in a subsequent gaming session as described above with respect to operation 404. The data store may store session records in a structured, queryable format, such as a document-based or key-value store, using the player credential as a key.

In some embodiments, the server 141 may receive a reset request associated with the player credential, such as a request from the first gaming device indicating that the user wishes to restart from a default state. In response to the reset request, the server 141 may replace the saved session record (or a particular save slot) in the data store with an initial session record comprising default values, such as a starting location, an empty inventory, no quest progress, and no character selected.

In some embodiments, the game-specific attributes stored in the data store may include procedurally generated content, such as a dungeon layout or world map. The server 141 may synchronize the procedurally generated content across the plurality of gaming devices connected to the server 141 via the network 139, such that all players engaging with a particular game title experience the same procedurally generated environment during a given time period. The procedurally generated content may be updated over a defined timeframe and redistributed by the server 141 to each connected gaming device.

In some embodiments, the server 141 may receive the same player credential from a second gaming device of the plurality of gaming devices, for example when the user logs into a different pinball machine at a different location. The server 141 may retrieve the updated session record stored at operation 410 and transmit the updated session record to the second gaming device, causing the second gaming device to configure gameplay based on the updated session record in the same manner as described above with respect to operation 406. In this way, the process 400 supports cross-device state persistence, enabling the user to continue gameplay on any gaming device connected to the server 141 via the network 139.

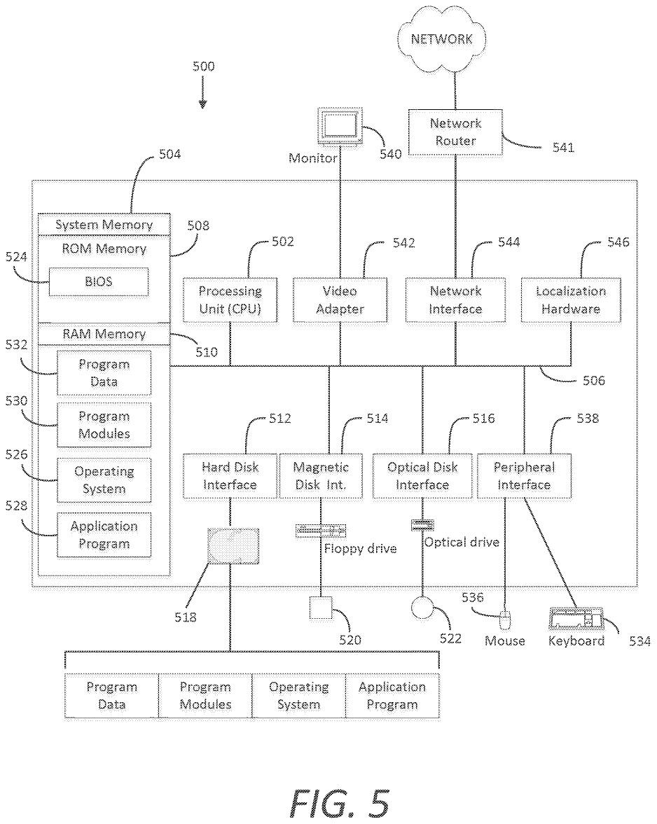

FIG. 5 is a block diagram of an example computing system 500. The pinball machine 110 and/or the server 141 may be embodied by or may include a computing system 500. When the computing system 500 embodies the server 141, the computing system 500 may include a data store, such as one or more databases or storage systems accessible via the memory 504 or via a network-attached storage device, for storing session records in association with player credentials. The computing system 500 may further include a network interface, such as the network interface component 544, for communicatively coupling to a plurality of gaming devices via the network 139. A computing system 500 includes microcontrollers, system-on-chips, field-programmable gate arrays (FPGAs), single-board computers, and/or any other electronic device having the ability to execute instructions, such as those stored within a non-transitory computer-readable medium. Furthermore, while described and illustrated in the context of a single computing system 500, those skilled in the art will also appreciate that the various tasks described hereinafter may be practiced in a distributed environment having multiple computing systems 500 linked via a local-or wide-area network in which the executable instructions may be associated with and/or executed by one or more computing systems 500.

In its most basic configuration, the computing system 500 includes at least one processing unit 502 and at least one memory 504 linked via a bus 506. Depending on the exact configuration and type of computing system environment, memory 504 is volatile (such as RAM 510), non-volatile (such as ROM 508, flash memory, etc.) or some combination of the two.

Computing system 500 has additional features and/or functionality. For example, computing system 500 may also include additional storage (removable and/or non-removable) including, but not limited to, magnetic or optical disks, tape drives and/or flash drives. Such additional memory devices may be made accessible to the computing system 500 by means of, for example, a hard disk drive interface 512, a magnetic disk drive interface 514, and/or an optical disk drive interface 516. As will be understood, these devices, which may be linked to the system bus 506, respectively, allow for reading from and writing to a hard drive 518, reading from or writing to a removable magnetic disk 520, and/or for reading from or writing to a removable optical disk 522, such as a CD/DVD ROM or other optical media. The drive interfaces and their associated computer-readable media may allow for the non-volatile storage of computer-readable instructions, data structures, program modules and other data for the computing system 500. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable (e.g., computer-implemented) instructions, data structures, program modules or other data. Any such computer storage media may be part of computing system 500.

A number of program modules may be stored in one or more of the memory/media devices. For example, a basic input/output system (BIOS 524), containing the basic routines that help to transfer information between elements within the computing system 500, such as during start-up, may be stored in ROM 508. Similarly, RAM 510, hard drive 518, and/or peripheral memory devices may be used to store computer-executable instructions comprising an operating system 526, one or more applications programs 528, other program modules 530, and/or program data 532. Still further, computer-executable instructions may be downloaded to the computing system 500 as needed, for example, via a network connection. The applications programs 528 may include, for example, computer-readable instructions that, when executed by the processing unit 502, cause the processing unit 502 to perform functionalities described above.

An end-user may enter commands and information into the computing system 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processing unit 502 via interfaces such as, for example, a parallel port, game port, firewire, or a universal serial bus (USB). To view information from the computing system 500, a monitor 540 or other type of display device may also be connected to bus 506 via an interface, such as via video adapter 542. In addition to the monitor 540, the computing system 500 may also include other peripheral output devices, not shown, such as speakers and printers.

The computing system 500 may also utilize logical connections to one or more computing system environments. Communications between the computing system 500 and the remote computing system environment may be exchanged via a further processing device, such as a network router 541, that is responsible for network routing. Communications with the network router 541 may be performed via a network interface component 544. Thus, within such a networked environment, e.g., the Internet, wide area network (WAN), local area network (LAN), or other like type of wired or wireless network, it will be appreciated that program modules depicted relative to the computing system 500, or portions thereof, may be stored in the memory storage device(s) of the computing system 500.

The computing system 500 may also include localization hardware 546 for determining a location of the computing system 500. In embodiments, the localization hardware 546 may include, for example, a GPS antenna, an RFID chip or reader, a Wi-Fi antenna, or other computing hardware that may be used to capture or transmit signals that may be used to determine the location of the computing system 500.

While this disclosure has described certain embodiments, it is understood that the claims are not intended to be limited to these embodiments except as explicitly recited in the claims. On the contrary, the instant disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method of operating a pinball machine, the method comprising:
initiating, by the pinball machine, a first gaming session associated with a user identifier;
receiving, by the pinball machine in the first gaming session, user inputs from one or more game input devices;
updating a game state based on the received user inputs, the game state comprising one or more attributes associated with the user identifier;
transmitting the game state to a remote server for association with the user identifier;
initiating a second gaming session associated with the user identifier, the second gaming session occurring on the pinball machine or a different pinball machine connected to the remote server;
obtaining, from the remote server, the game state based on the user identifier; and
configuring the second gaming session based on the game state.

2. The method of claim 1, wherein the user identifier is received via an access device of the pinball machine, the access device comprising at least one of an optical reader configured to read a code presented by a user, a near field communications device, or a card reading device.

3. The method of claim 1, wherein initiating the first gaming session comprises transmitting the user identifier to the remote server, receiving an authentication response from the remote server, and determining, based on the authentication response, whether the user identifier is associated with a previously saved game state.

4. The method of claim 3, wherein, in response to determining that the user identifier is not associated with a previously saved game state, generating an initial game state comprising default values and associating the initial game state with the user identifier.

5. The method of claim 1, wherein the game state comprises user-specific attributes and game-specific attributes, the user-specific attributes comprising at least one of character selection data, inventory data, or progression data, and the game-specific attributes comprising at least one of map layout data, unlocked feature data, or score data.

6. The method of claim 1, wherein obtaining the game state comprises obtaining a plurality of game state objects associated with the user identifier, each game state object corresponding to a respective save slot, and wherein the method further comprises presenting the plurality of game state objects on a display of the pinball machine and receiving a user selection of one of the plurality of game state objects.

7. The method of claim 1, wherein the game state comprises procedurally generated content, and wherein the procedurally generated content is synchronized across a plurality of pinball machines connected to the remote server.

8. The method of claim 1, wherein configuring the second gaming session further comprises adjusting one or more virtual elements displayed on a display of the pinball machine based on the game state, the one or more virtual elements comprising at least one of a character avatar, an in-game map, or a score metric.

9. The method of claim 1, wherein transmitting the game state to the remote server comprises periodically transmitting updated versions of the game state during the first gaming session at defined checkpoints.

10. The method of claim 9, wherein the defined checkpoints comprise at least one of an end-of-ball event, a mode completion event, or a user logout event.

11. A pinball machine, comprising:
a display;
a playfield and a plurality of playfield accessories; and
one or more processors are configured to perform operations comprising:
initiating a first gaming session associated with a user identifier;
receiving, by the pinball machine in the first gaming session, user inputs from one or more game input devices;
updating a game state based on the received user inputs, the game state comprising one or more attributes associated with the user identifier;
transmitting the game state to a remote server for association with the user identifier;
initiating a second gaming session associated with the user identifier, the second gaming session occurring on the pinball machine or a different pinball machine connected to the remote server;
presenting a plurality of game state objects on the display of the pinball machine, the plurality of game state objects comprising the game state; and
in response to receiving a user selection of the game state from the plurality of game state objects, configuring the second gaming session based on the game state, the configuring comprising adjusting one or more of the playfield accessories to reflect the game state.

12. The pinball machine of claim 11, wherein adjusting one or more of the playfield accessories comprises at least one of activating or deactivating a bumper, enabling or disabling access to a ramp, activating or deactivating a drop target, or illuminating a rollover switch.

13. A computing system for maintaining state between pinball machines, comprising:
a data store;
a network interface communicatively coupled to a plurality of pinball machines each having a playfield and a set of electromechanical components; and
one or more processors are configured to perform operations comprising:
receiving, from a first pinball machine of the plurality of pinball machines, a user credential;
obtaining a saved session record associated with the user credential in the data store;
causing the first pinball machine to configure the playfield based on the saved session record, the configuring comprising selectively activating or deactivating at least one of the electromechanical components according to the saved session record;
receiving, from the first pinball machine, an updated session record reflecting gameplay changes occurring during a current gaming session; and
storing the updated session record in the data store in association with the user credential.

14. The computing system of claim 13, wherein the saved session record comprises user-specific attributes and game-specific attributes accumulated during one or more prior gaming sessions on one or more of the plurality of pinball machines.

15. The computing system of claim 14, wherein the game-specific attributes comprise procedurally generated content, and wherein the operations further comprise synchronizing the procedurally generated content across the plurality of pinball machines.

16. The computing system of claim 13, wherein the operations further comprise:
identifying a plurality of saved session records associated with the user credential, each saved session record corresponding to a respective save slot; and
causing the first pinball machine to present a selection interface comprising the plurality of saved session records.

17. The computing system of claim 13, wherein the operations further comprise:
receiving, from a second pinball machine of the plurality of pinball machines, the user credential; and
causing the second pinball machine to configure gameplay based on the updated session record.

18. The computing system of claim 13, wherein the operations further comprise:
validating the updated session record received from the first pinball machine; and
generating a version identifier associated with the updated session record prior to storing the updated session record in the data store.

19. The computing system of claim 13, wherein the operations further comprise:
in response to receiving a reset request associated with the user credential, replacing the saved session record in the data store with an initial session record comprising default values.

20. The computing system of claim 13, wherein the data store maintains a plurality of prior versions of the saved session record, and wherein the operations further comprise causing the first pinball machine to present a version selection interface comprising the plurality of prior versions.
